(19) United States
(12) Patent Application Publication
(10) Pub. No.: US 2005/0137878 A1
(43) Pub. Date: Jun. 23, 2005

(54) Automatic voice addressing and messaging methods and apparatus

(75) Inventors: Daniel L. Roth, Boston, MA (US); Laurence S. Gillick, Newton, MA (US); Jordan Cohen, Gloucester, MA (US); William Barton, Harvard, MA (US)

Correspondence Address: WILMER CUTLER PICKERING HALE AND DORR LLP, 60 STATE STREET, BOSTON, MA, 02109, US

(73) Assignee: Voice Signal Technologies, Inc., Wobum, MA (US)

(21) Appl. No.: 10/938,419

(22) Filed: Sep. 10, 2004

Related U.S. Application Data
(60) Provisional application No. 60/501,967, filed on Sep. 11, 2003.

(51) Int. Cl. G10L 21/00

(52) U.S. Cl. 704/275

(57) ABSTRACT

A method of operating a device that includes speech recognition capabilities includes implementing on a device a plurality of user interfaces, wherein at least one said user interfaces is a voice interface. The method also includes launching a first application, and as part of launching the first application, launching a second application, the second application optionally presenting to a user at least one query using the voice interface and populating an address field in the first application in response to the query using the speech recognition capabilities. The second application is launched either simultaneously or subsequent to the launching of the first application. Populating the address field comprises accessing address information from a plurality of databases resident in the device.

### CROSS-REFERENCE TO RELATED APPLICATIONS

This application claims benefit to U.S. Provisional Patent Application Ser. No. 60/501,967 filed Sep. 11, 2003, the entire contents of which are incorporated herein by reference.

### TECHNICAL FIELD

This invention relates to wireless communication devices having speech-recognition capabilities.

### BACKGROUND

Messaging applications have become a major part of modem computing, and are an important part of the infrastructure of modern handheld computing devices. Users of the GSM (global system for mobile communications) telephone infrastructure now send more than 1.5 Billion SMS (short messaging service) messages each day, and the revenue from this stream is about 20% of the profit of the European telecommunications carriers. There are more than 90 million users of Instant Messaging, made popular by providers, for example, AOL and by ICQ (now Microsoft), and there is increasing enterprise use of this fast text-based messaging infrastructure (Giga Information Group). Email (electronic mail) has become an ubiquitous medium of exchange between people and organizations.

Modern cellular telephones and other networked handheld computing devices are handicapped when using text interfaces because they lack the keyboard/screen/mouse interface used in standard computers. This deficit can be overcome by judicious use of voice interfaces, and by the development of new voice interfaces previously assumed to be impossible.

Existing commercial devices now contain voice interfaces which allow command and control navigation of the device interface (for example, Samsung a500); continuous digit recognition allowing dialing of a cell phone without use of the keypad (for example, Samsung a500), and name lookup allowing a user to call anyone who is listed in the contact list of the device (for example, Samsung i700). Each of these applications is speaker independent, and requires no training by the user of the device.

Cellular telephones (cell phones) and other networked handheld devices are usually capable of exchanging SMS messages and email, and some of them are equipped with an instant messaging client. These devices have such applications included in the native operating system or in the standard release of the software for the device.

Another technology which is in development is that of speech-to-text on a small device. That is, it is now possible to convert spoken words to text with very short delay and with high accuracy on a cell phone or a PDA (personal digital assistant).

### SUMMARY OF THE INVENTION

In general, according to one aspect of the invention, a method of operating a device that includes speech recognition capabilities includes implementing on a device a plurality of user interfaces, wherein at least one said user interfaces is a voice interface. The method also includes launching a first application, and as part of launching the first application, launching a second application, the second application optionally presenting to a user at least one query using the voice interface and populating an address field in the first application in response to a speech input using the speech recognition capabilities. The second application is launched either simultaneously or subsequent to the launching of the first application. Populating the address field comprises accessing address information from a plurality of databases resident in the device. The first application includes, but is not limited to, one of SMS (short messaging service), MMS (multimedia messaging service), name dial, name look-up, email (electronic mail), push-to-talk, instant messaging, and accessing a browser. The first application is launched using a voice interface or a keypad interface. In an embodiment, the verbal prompting provided by the second application is optional. The device may operate in a mode wherein the verbal prompts are turned off and replaced with earcons or silence for the experienced user.

In accordance with another aspect of the invention, a computer readable medium having stored instructions adapted for execution on a processor including instructions for launching a first application; instructions for launching a second application in response to launching said first application; instructions for receiving a spoken response to access a database entry; and instructions for populating an address field in said first application using information in said database entry. The computer readable medium is disposed within a mobile telephone apparatus and operates in conjunction with a user interface and speech recognition capabilities. The computer readable medium in the second application is launched either simultaneously or subsequent to said launching of the first application. The database entry is resident in an apparatus in local communication with the processor. The first application includes, but is not limited to, one of SMS (short messaging service), MMS (multimedia messaging service), name dial, name look-up, email (electronic mail), push-to-talk, instant messaging, and accessing a browser. The first application is launched using a voice interface or a keypad interface.

The foregoing and other objects, features and advantages of the invention will be apparent from the following more particular description of embodiments of the invention, as illustrated in the accompanying drawings.

### BRIEF DESCRIPTION OF THE DRAWINGS

FIG. 1 is a flow diagram showing an example of the operation of a mobile communication device having the capability of automatic voice addressing and messaging.

FIG. 2 is a block diagram of an exemplary cellular telephone on which the functionality described herein can be implemented.

### DETAILED DESCRIPTION

The convergence of the capabilities, i.e., SMS messaging, email and speech-to-text technologies, allows for a convenient, flexible, intuitive messaging suite for use in a handheld mobile communication device according to the present invention which does not have a fully functional text keyboard or a large screen or both. The embodiments are directed at automatically generating a pointer to a recipient of a messaging application upon launching the messaging application.

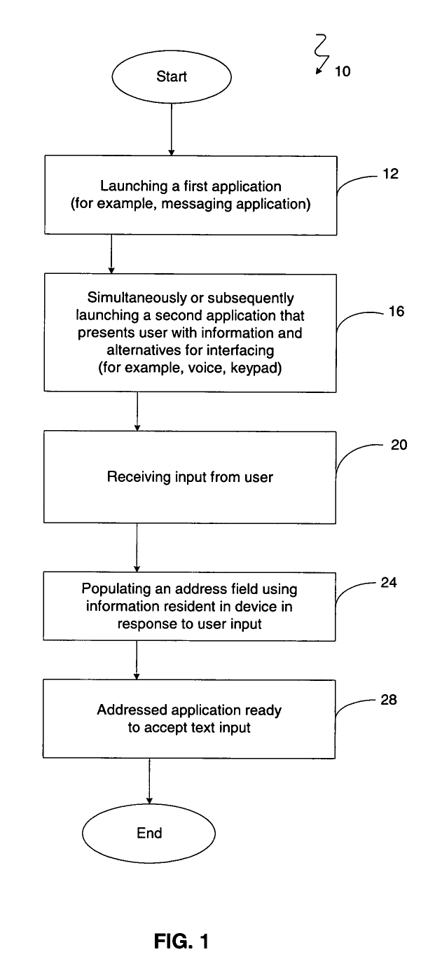

FIG. 1 is a block diagram illustrating the operation of a mobile communication device having the capability of automatic voice addressing and messaging. The user launches a first application such as a messaging application per step 12. The messaging application, for example, an SMS client, is launched using a command and control recognizer (or a keypad on the device).

Either simultaneously with that launch or subsequent to it, a second application is launched per step 16 that presents the user with multiple alternatives for interfacing with the device such as voice, keypad, stylus, etc. This second application speeds up the addressing of the first messaging application by presenting the user with information using a voice interface or a keypad interface. The device receives an input from the user, per step 20, possibly in response to a query. A speech recognizer is resident in the device. The device uses a Name Recognizer to look up, for example, the SMS address of a person from the contact list of the device. Alternatively, in a full multimodal interface, the address may be found by navigating through the phone book and selecting the address with buttons. For SMS, the address is the phone number; for email, it is customary to have the email address as part of the contact information in the device. For Instant Messaging, the application keeps a “buddy list” of people associated with each chat room, and that buddy list may be referenced by speech in a similar fashion. For a message to someone not included in the contact list, one may enter the phone number using the speaker independent number recognition system, or may speak an email address using an appropriate recognizer.

The second application then causes the first application to open with an address of the recipient filled in per step 24. This addressed application is ready to receive text which forms the body of the message per step 28. The application may launch the speech-to-text algorithm or sequence of executable instructions, and may listen for speech input. The user can either speak to the device, observing the text created from his speech, and accepting, editing, or otherwise interacting with the text; or insert characters into the editor, using the keypad on a phone, or using a pop-up virtual keypad on a PDA, or some other interface that has been developed for creating text.

In an embodiment, the verbal prompting provided by the second application is optional. The device may operate in a mode wherein the verbal prompts provided to the user are turned off and replaced with earcons or silence for the experienced user.

Using the command and control recognizer or a keypad on the device, the user may now send the message to the intended recipient, or he may cancel or store the message.

The confluence of the voice capabilities in conjunction with the native capabilities of mobile devices thus allows rapid and intuitive messaging interfaces on wireless mobile devices. This process may be fully voice controlled, or may be a mixed mode application. If fully voice controlled, the process may be hands-free and eyes-free.

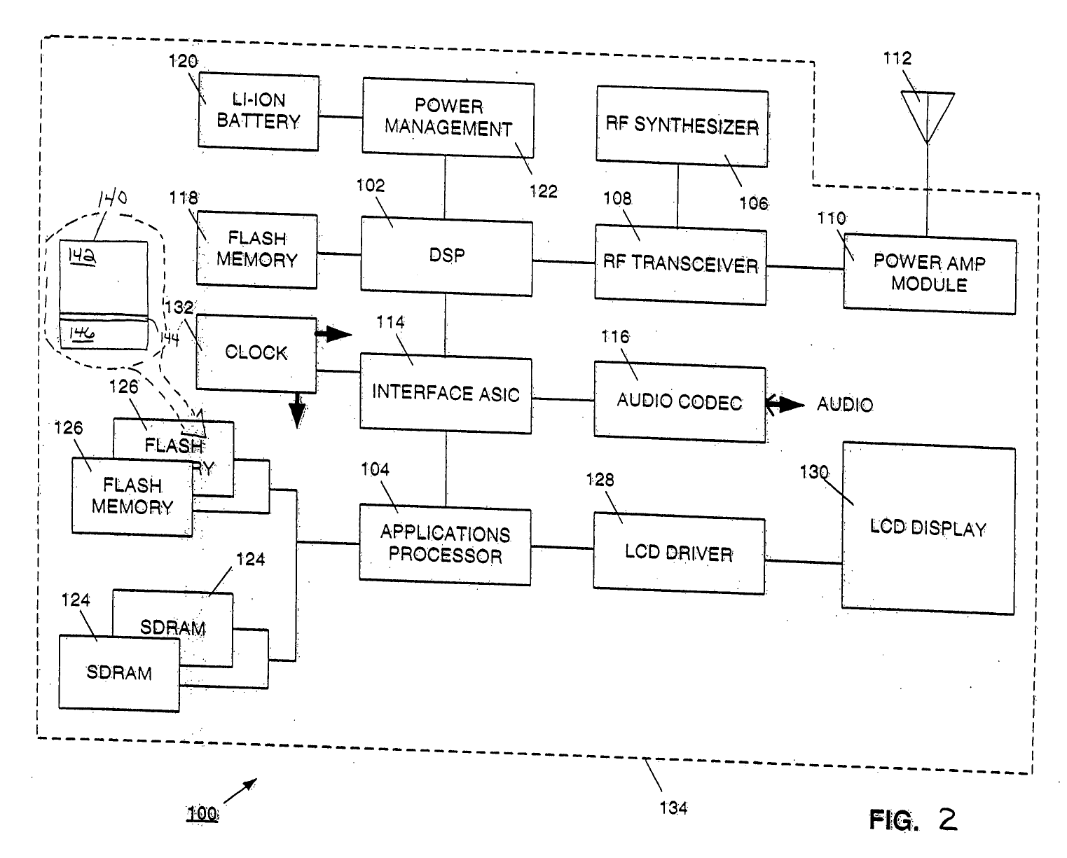

A typical platform on which such functionality can be provided is a smartphone 100, such as is illustrated in the high level block diagram form in FIG. 2. The platform is a cellular phone in which there is embedded application software that includes the relevant functionality. In this instance, the application software includes, among other programs, voice recognition software that enables the user to access information on the phone (for example, telephone numbers of identified persons) and to control the cell phone through verbal commands. The voice recognition software also includes enhanced functionality in the form of a speech-to-text function that enables the user to enter text into an email message through spoken words.

In the described embodiment, smartphone 100 is a Microsoft PocketPC-powered phone which includes at its core a baseband DSP 102 (digital signal processor) for handling the cellular communication functions including, for example, voiceband and channel coding functions and an applications processor 104 (for example, Intel StrongArm SA-1110) on which the PocketPC operating system runs. The phone supports GSM voice calls, SMS (Short Messaging Service) text messaging, wireless email (electronic mail), and desktop-like web browsing along with more traditional PDA features.

The transmit and receive functions are implemented by an RF synthesizer 106 and an RF radio transceiver 108 followed by a power amplifier module 110 that handles the final-stage RF transmit duties through an antenna 112. An interface ASIC 114 (application specific integrated circuit) and an audio CODEC 116 (coder/decoder) provide interfaces to a speaker, a microphone, and other input/output devices provided in the phone such as a numeric or alphanumeric keypad (not shown) for entering commands and information.

The DSP 102 uses a flash memory 118 for code store. A Li-Ion (lithium-ion) battery 120 powers the phone and a power management module 122 coupled to DSP 102 manages power consumption within the phone. Volatile and non-volatile memory for applications processor 114 is provided in the form of SDRAM 124 (synchronized dynamic random access memory) and flash memory 126, respectively. This arrangement of memory is used to hold the code for the operating system, the code for customizable features such as the phone directory, and the code for any applications software that might be included in the smartphone, including the voice recognition software mentioned hereinafter. The visual display device for the smartphone includes an LCD (liquid crystal display) driver chip 128 that drives an LCD display 130. There is also a clock module 132 that provides the clock signals for the other devices within the phone and provides an indicator of real time.

All of the above-described components are packages within an appropriately designed housing 134.

Since the smartphone described herein is representative of the general internal structure of a number of different commercially available smartphones and since the internal circuit design of those phones is generally known to persons of ordinary skill in this art, further details about the components shown in FIG. 2 and their operation are not being provided and are not necessary to understanding the invention.

The internal memory of the phone includes all relevant code for operating the phone and for supporting its various functionality, including code 140 for the voice recognition application software, which is represented in block form in FIG. 2. The voice recognition application includes code 142 for its basic functionality as well as code 144 for enhanced functionality, which in this case is speech-to-text functionality 144. The code or sequence of executable instructions for automatic voice addressing and messaging as described herein are stored in the internal memory of the communication device and as such can be implemented on any phone or device having an application processor.

In view of the wide variety of embodiments to which the principles of the present invention can be applied, it should be understood that the illustrated embodiments are exemplary only, and should not be taken as limiting the scope of the invention. For example, the steps of the flow diagram (FIG. 1) may be taken in sequences other than those described, and more or fewer elements may be used in the diagrams. While various elements of the preferred embodiments have been described as being implemented in software, other embodiments in hardware or firmware implementations may alternatively be used, and vice-versa.

It will be apparent to those of ordinary skill in the art that methods involved in automatic voice addressing and creation of SMS and email using voice may be embodied in a computer program product that includes a computer usable medium. For example, such a computer usable medium can include a readable memory device, such as, a hard drive device, a CD-ROM, a DVD-ROM, or a computer diskette, having computer readable program code segments stored thereon. The computer readable medium can also include a communications or transmission medium, such as, a bus or a communications link, either optical, wired, or wireless having program code segments carried thereon as digital or analog data signals.

Other aspects, modifications, and embodiments are within the scope of the following claims.

1. A method of operating a device that includes speech recognition capabilities, said method comprising:
implementing on a device a plurality of user interfaces, wherein at least one of said user interfaces is a voice interface;
launching a first application;
in response to launching the first application, launching a second application, the second application receiving a speech input from a user using the voice interface; and
the second application populating an address field of the first application in response to said speech input.

2. The method of claim 1, wherein the second application is launched either simultaneously or subsequent to the launching of the first application.

3. The method of claim 1, further comprising the second application presenting at least one query using the voice interface.

4. The method of claim 1, wherein populating the address field comprises accessing address information from at least one of a plurality of databases resident in the device.

5. The method of claim 1, wherein the first application is selected from a group comprising of SMS (short messaging service), MMS (multimedia messaging service), name dial, name look-up, email (electronic mail), push-to-talk, instant messaging, and accessing a browser.

6. The method of claim 1, wherein the first application is launched using a voice interface.

7. The method of claim 1, wherein the first application is launched using a keypad interface.

8. A computer readable medium including stored instructions adapted for execution on a processor including:
instructions for launching a first application;
instructions for launching a second application in response to launching said first application;
instructions for receiving a spoken response to access at least one database entry; and
instructions for populating an address field in said first application using information in said at least one database entry.

9. The computer readable medium of claim 8, wherein the medium is disposed within a mobile telephone apparatus and operates in conjunction with a user interface and speech recognition capabilities.

10. The computer readable medium of claim 8, wherein the second application is launched either simultaneously or subsequent to said launching of the first application.

11. The computer readable medium of claim 8, wherein said at least one database entry is resident in an apparatus in local communication with the processor.

12. The computer readable medium of claim 8, wherein the first application is selected from a group comprising of SMS (short messaging service), MMS (multimedia messaging service), name dial, name look-up, email (electronic mail), push-to-talk, instant messaging, and accessing a browser.

13. The computer readable medium of claim 8, wherein the first application is launched using a voice interface.

14. The computer readable instructions of claim 8, wherein the first application is launched using a keypad interface.
